(19) United States
(12) Patent Application Publication
(10) Pub. No.: US 2015/0056359 A1
(43) Pub. Date: Feb. 26, 2015

(54) INTEGRAL SAUTEED PEPPERS AND ONIONS CONDIMENT/SAUCE FOR FLAVOR AND AROMA ENHANCEMENT OF FOODS

(71) Applicants: Robert Jensen, Plainview, NY (US); Larissa Jensen, Plainview, NY (US)

(72) Inventor: Robert Jensen, Plainview, NY (US)

(21) Appl. No.: 14/460,283

(22) Filed: Aug. 14, 2014

Related U.S. Application Data
(60) Provisional application No. 61/866,662, filed on Aug. 16, 2013.

(51) Int. Cl. A23L 1/221; A23L 1/39

(52) U.S. Cl. CPC A23L 1/2212; A23L 1/39; A23V 2002/00
USPC 426/589

(57) ABSTRACT

A flavor and aroma enhancer cooking sauce in which pureed peppers and onions are cooked/sautéed to achieve a caramelization, into a pourable viscous formula that can be easily used on a variety of foods as a condiment, dipping sauce, marinade or recipe flavor and aroma enhancer of authentic Ethnic style sautéed peppers and onions.

### RELATED APPLICATIONS

This application is based upon Provisional Application No. 61/866,662, filed Aug. 16, 2013, which application is incorporated by reference herein. Applicant claims priority under 35U.S.C.119 (e) therefrom.

### TECHNICAL FIELD

The present disclosure relates generally to a Composition and method for an integral sautéed peppers and onions condiment/sauce for flavor and aroma enhancement of foods.

### BACKGROUND OF THE INVENTION

All patents, scientific articles and other documents mentioned herein are expressly incorporated by reference as if reproduced in full.

Onions of the botanical genus of Allium are well known ingredients in dishes around the world. Onions are capable of imparting a distinct taste and aroma to foodstuff. When freshly preparing foodstuffs in which the aroma and tastes of onions is desired, this will generally involve cutting or chopping onions which are then fried or sautéed for several minutes, usually in oil or butter.

Bell pepper, also known as sweet pepper or a pepper (in the United Kingdom and Ireland) and capsicum (in India, Australia and New Zealand), is a cultivar group of the species Capsicum annuum. Cultivars of the plant produce fruits in different colors, including red, yellow, orange, green, chocolate/brown, vanilla/white, and purple. Bell peppers are sometimes grouped with less pungent pepper varieties as “sweet peppers”. Optionally “hot” peppers such as jalapeno, chili, scotch bonnet, cayenne or cerano peppers can be used for a more spicy condiment. Mexican chili peppers which are smoked, dried jalapeno peppers, known as chipotle peppers, may optionally be used.

A sautéed mixture of peppers and onions is a well-known compliment to ethnic sausage, such as Italian, Polish, Greek, German, Spanish or other ethnic delicacies, and may also compliment other meats, such as turkey, chicken, pork, lamb, poultry, fish, beef as well as eggs, vegetables, stews or vegetarian substitutes. Traditionally, peppers and onions are cut into an appropriate size and added to hot oil such as for example extra virgin (EVOO) for cooking. The oil, peppers and onions must be continually stirred in order to promote softening and browning of the peppers and onions. Also, in order to obtain the desired aroma and texture, such cooking is conducted almost immediately prior to use.

In the ever increasing range of convenience food, which is partly or fully cooked, the addition of sautéed onions and peppers is in many cases a desired attribute. The industrial manufacturer may achieve this by incorporating onions and/or peppers in the foodstuff at some stage in the industrial process. Such onions and/or peppers may be freshly prepared, dried or frozen, or otherwise processed. Although this may provide acceptable results with respect to taste, the general experience is that a so-prepared foodstuff will in most cases lack the agreeable aroma of freshly sautéed onions and peppers, which the user will perceive when freshly preparing a dish with onions and peppers which are sautéed during the preparation of the dish.

When incorporating onions and peppers in a fully or partly prepared foodstuff, the distinct aroma of onions and peppers is apparently lost at some stage during processing to such an extent that when the consumer opens the packaging of said foodstuff and heats or finishes the preparation prior to consumption, the aroma is not acceptable compared to freshly prepared ingredients.

Although the taste may be improved by incorporating in said foodstuff a “onion” and/or “pepper” flavor as supplied by various flavor manufacturers, the results in term of onion and pepper aroma are still disappointing in many respects.

U.S. Pat. No. 6,787,174B2 of Tanabe describes a method of manufacturing sautéed onions.

European patent application EP 1 038 450 A1 of Unilever describes making an artificial aroma of sautéed onions, not using actual onions (i.e. Allium plants).

U.S. Pat. No. 6,284,303 of Rowe describes a vegetable based creamy food product made of pumpkin vegetable matter, oil and starch.

Japanese Patent JP4489602 B2 describes a sautéed onion product for boiled and cooked foods, where the onion is pressed with centrifugal force in a rotating agitator and heated, whereby the water content becomes 45-55 weight percentage of the total processed onion.

However, these patents do not describe a method of preparing an integral peppers and onions flavor and aroma enhancer sauce for foods, which retains the authentic aroma of Italian, Polish, Greek, German or Spanish or other ethnic style peppers and onions, typically used on ethnic style sausage meat (including but not limited to Italian, Polish, Greek, German or Spanish or other ethnic style sausage meat).

### SUMMARY OF THE INVENTION

The integral sautéed peppers and onions sauce of the present invention can be used on other foods, in addition to sausage, (all ethnic sausages, including but not limited to Italian, Polish, German, Greek or Spanish chorizo), where the authentic sautéed peppers and onions flavor and aroma reminiscent of ethnic style cooking is desired. This sautéed mixture of peppers and onions is a well-known compliment to ethnic sausage, (such as, but not limited to, Italian, Polish, German, Greek or Spanish chorizo sausages) or other ethnic delicacies, and may also compliment other meats, such as turkey, chicken, pork, lamb, poultry, fish, beef as well as eggs, vegetables, stews or vegetarian substitutes”.

It is therefore an object of the present invention to provide an integral sautéed peppers and onions sauce for flavor and aroma enhancement of foods with authentic sautéed peppers and onion flavoring, without the use of artificial ingredients.

It is also an object of the present invention to provide a cooking sauce of a combination of peppers and onions in a puree or other blended combination, such as being crushed, minced liquefied or finely chopped, or combinations thereof, which captures the authentic aroma of sautéed peppers and onions without artificial ingredients. Other objects will become apparent from the following description of the present invention.

In order to obtain organoleptic properties of taste which approximates real cooked peppers and onions, the sauce of the present invention has the following minimum ingredients:

Onions

Peppers

Oil (selected from the group consisting essentially of extra virgin olive oil, canola oil, vegetable oil (soy based)

Vinegar (selected from the group consisting essentially of while vinegar, red vinegar, balsamic vinegar and apple cider vinegar)

Water.

Preferable but optional ingredients include thickeners, such as corn starch or rice starch, which may be added, as well as spices selected from the group consisting essentially of oregano, black pepper, salt (iodized or sea salt), garlic powder and onion powder.

### BRIEF DESCRIPTION OF DRAWINGS

The present invention can be described conceptually in the following drawing figures, without limitation, as follows:

FIG. 1 is a flow chart outlining the problems solved with the condiment/sauce of the present invention; and

FIG. 2 is a flow chart of the process of making the condiment/sauce of the present invention.

### DETAILED DESCRIPTION

The present invention is an integral sautéed peppers and onions sauce to enhance the flavor and aroma of food. The sauce includes peppers and onions that are cooked/sautéed, preferably in oil and additional flavors, to achieve a caramelization, then pureed into a pourable viscous final product that can be easily used on a variety of foods as a condiment, dipping sauce, marinade or recipe flavor and aroma enhancer of authentic Italian, Polish, German, Greek or Spanish chorizo or other ethnic style sautéed peppers and onions. The onions are of the botanical genus of Allium which are well known ingredients in dishes around the world. The peppers are preferably bell peppers, also known as sweet pepper or a pepper (in the United Kingdom and Ireland) and capsicum (in India, Australia and New Zealand), is a cultivar group of the species Capsicum annuum. Cultivars of the plant produce fruits in different colors, including red, yellow, orange, green, chocolate/brown, vanilla/white, and purple.

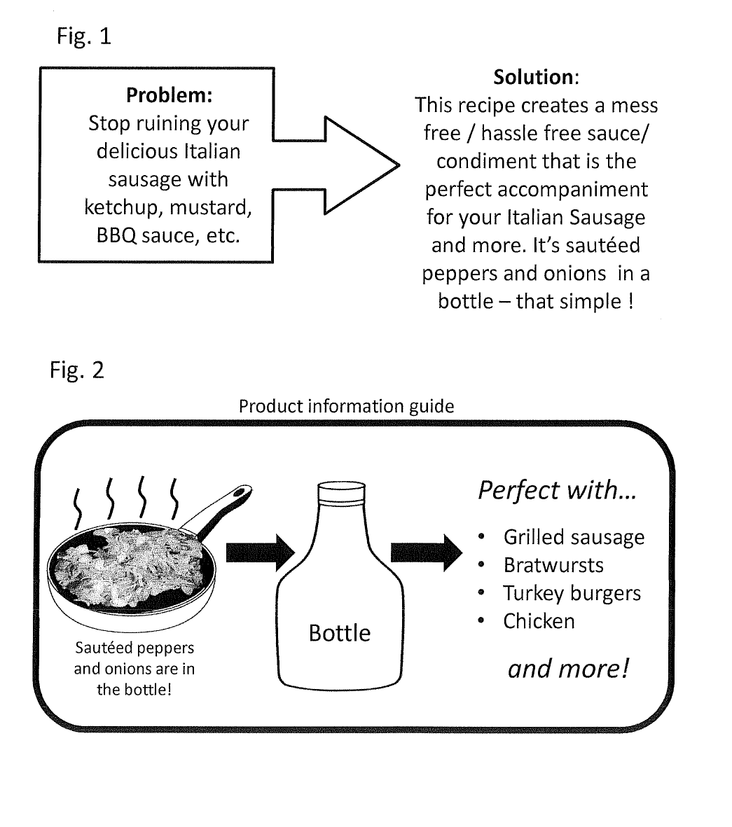

As shown in FIGS. 1 and 2 generally, the present invention takes sautéed/cooked peppers and onions to produce a sauce, which is preferably bottled for sale as a condiment. Besides being suitable for Italian, Polish, German, Greek or Spanish chorizo or other ethnic style sausages, it also complements other turkey, chicken, pork, lamb, poultry, fish, beef, egg, vegetable or stew recipes, as well as vegetarian equivalents thereof.

Following the above, an integral sautéed peppers and onions sauce and method for making such sauce imparts an onion and pepper aroma or odor to a foodstuff. The main ingredients of the present sauce are sautéed onions and peppers. The onions and peppers, which are used in natural form, as puree, are used as the main texture and mouth-feel imparting component. The onions are preferably present in amounts of 25 to 60 percentage by weight (wt. %) based on the final product, more preferably 40-55 wt. % based on the final product. The peppers are preferably present in amounts of 25 to 60 wt % based on the final product, more preferably 40-55 wt. % based on the final product. Mixed together, the peppers and onions may comprise up to 85% of the total weight of the composition. The sauce may further comprise oil, vinegar, water, spices and stabilizers and is suitable for storage in refrigerated, frozen, and shelf-stable forms. The sauce may be used to make condiments, spreads, dips, dressings, sauces, marinades, vegetable toppings, pates, filings for baked goods, beverages, soups and soup enhancers are include among the creamy foods contemplated by the present invention.

The sauce of the present invention is a product, prepared by the process of the present invention, which is made from main ingredients including natural onions and natural peppers. The sauce of the present invention is intended to be made available commercially, and thus is to be commercially processed. Surprisingly, it has been found that an integral sautéed pepper and onions sauce provides a healthier alternative without compromising functionality.

Onions and bell peppers of all types including, but not limited to, yellow onions, green peppers and red peppers were found to be acceptable for use as the base for the sauce and suitable for imparting their texture and flavor to the food.

Oil will preferably be present in amounts within the range of from about 0 to 40 percent based on the weight of the final product and most preferably in an amount of from 10-20 percent of the weight of the final product. The term “oil” as used herein is intended to include all edible, fatty acid triglycerides regardless of origin or whether they are solid or liquid at room temperature. Typical of the vegetable oils, which are includes, are the usual vegetable oils such as soybean oil, corn oil, cottonseed oil peanut oil, safflower oil, sunflower oil, palm oil and rape-seed oil. The preferred oils for use in the invention will comprise soybeans oil, olive oil, corn oil, and butter. Most preferred oils are soybean oil and olive oil. The oils provide lubricity to the composition and keep the total moisture content low. Furthermore, water may be added to the composition such that it comprises about 0 to 40 percent based on the weight of the final product and most preferably in an amount of from 1-20 percent of the weight of the final product.

As a stabilizer various thickeners may be used to provide the necessary texture. These can be any of those known to the art for this purpose and will preferably be starches, gums, polysorbate 60 (an emulsifier) and the like and mixtures of these. Corn starch is the preferred starch, which acts as a binder and thickener although rice starch may be optionally used. Examples of gums that may be used are xanthan gum, guar gum, corn starch and carrageenan, which serve as thickeners. The stabilizer can be employed in any amount effective under the conditions of processing and with the particular ingredients. The levels of about 0 to 5 percent, preferably 1 to 5% starch, and 0 to 0.5 percent gums, based on the weight of the total composition, are particularly effective. In addition to their emulsion stabilizing function, these materials also have a viscosity-increasing effect on the composition. Typically, the gums will be dissolved or dispersed in the oil or the water phase to avoid clumping.

The preferred products of the invention may include suitable colorings and flavorings known in the art for these purposes. Representative of the flavor and/or flavor enhancers will be sodium chloride, spices, herbs, and natural and synthetic flavors, as well as vegetable matter itself. In one preferred embodiment, the flavorings include oregano, black pepper, sea salt, garlic powder, thyme, basil and/or and onion powder. Each of these colorings and flavorings are preferably present at levels of less than 1 percent by weight, based on the final product.

Vinegar may be added to the formulation for both a preservative effect (pH lowering) and flavor enhancer, while other vinegars can be used, such as red wine vinegar and white vinegar, preferably the vinegar is apple cider vinegar. A critical feature is that the final product preferably has a sufficient amount of acidic vinegar such that a pH balance of about 4.5 or less, preferably 4.3 or less, is maintained. Vinegar may be added to the composition such that it comprises about 1 to 40 percent based on the weight of the final product and most preferably in an amount of from 5-20 percent of the weight of the final product, to keep the pH below the critical pH of 4.5.

A preferred method for making the sauce includes the steps of preparing de-seeded peppers and onions at a suitable size. In one embodiment, the size for the de-seeded peppers and onions is ¼-½ wide by one inch long. Alternatively, the de-seeded peppers and onions may be pureed to a size such that the de-seeded peppers and onions may pass through a 0.375 inch diameter orifice. The resulting peppers and onions are then heated until the vegetables are soft and caramelized. In one embodiment, the resulting peppers and onions are heated at a temperature of 200-300° F. for 20-40 minutes until the vegetables are soft and caramelized. If needed, the cooked ingredients may be further pureed in a blender to obtain the desired consistency. Oil, vinegar and water are preferably added to the peppers and onions mixture prior to heating. Additionally, any thickeners, flavors, and/or spices are preferably added to the peppers and onions mixture prior to heating. In one embodiment, all of the ingredients are added together and delivered to a steam jacketed Kettle Cooker at a temperature of 200-300° F. for 30-45 minutes until the vegetables are soft and caramelized. A thickener agent can be added, after cooking to get desired viscosity (thickness).

A preferred method for making the sauce includes the steps of pre-heating a frying pan or equivalent heat source, preparing red peppers and green peppers by washing thoroughly, cutting open and de-seeding the peppers, dicing the peppers into slices of from ¼ inch to one inch wide, preparing onions by peeling off skins and chopping into slices ranging from ½ inch to one inch wide, combining the prepared vegetables with all remaining ingredients into the pre-heated nonstick fry pan or equivalent heating source, cooking the product over medium heat at 200-300° F. for 20-40 minutes, stirring occasionally, until vegetables are soft and caramelized, allowing the cooked ingredients to cool slightly in the nonstick fry pan or equivalent heat source, placing the contents of nonstick fry pan into a blender, and using a puree setting for 10-45 seconds until desired consistency is achieved. When processed, the consistency of the product should range as follows: a) at the thinnest,: to a consistency of a thick salad dressing (like ranch dressing), orb) at the thickest,: to a consistency of a yellow mustard (such as Gulden's Spicy Brown Mustard®).

The following method steps are for special manufacturing considerations for producing multiple quantities of the present invention: (when recipe is scaled up to manufacture). For example, due to process limitations in manufacture, vegetables are pureed first or otherwise blended in a combination such as being crushed, minced, liquefied, finely chopped or combinations thereof, and then cooked afterwards. The manufacturer has to strain or puree to desired consistency to be able to pour out of a 0.375 orifice in flip cap. After the puree or other blended combination is produced in sufficient quantities, all ingredients are preferably combined into a steam jacketed Kettle Cooker or equivalent heating means. The ingredients are cooked at a temperature of about 200-300 degrees for 30-45 minutes, while being stirred occasionally. Xanthan gum, guar gum, corn starch or carrageenan is preferably added as a thickener as needed to achieve viscosity. After cooking, the product is heat filled into bottles, then cap. For maximum organoleptic taste qualities, a critical feature is that the product should maintain a pH balance below about 4.5, preferably below 4.3.

It should be understood that the foregoing descriptions are only illustrative of the disclosure. Various alternates and modifications may be devised by those skilled in the art, without departing from the disclosure. For example the amounts of each component may be adjusted, as appropriate for each particular type of component employed. Accordingly, the present disclosure and invention is intended to embrace all such alternatives, modifications and variances which fall within the scope of the present invention.

### Example 1

In the preferred embodiment for a 15 oz bottle, the following recipe is used:

Recipe: (Ingredients fill one 15 oz. plastic squeeze bottle)

### Preferred Embodiment

2 Medium Onions—about 330 grams total for both

1 Green Pepper about—200 grams

1 Red Pepper—about 225 grams

about ¼cup Extra Virgin Olive Oil (EVOO)

about ⅓ cup apple cider vinegar

about ¾ cup water

about ¾ teaspoon oregano

about ¼ teaspoon black pepper

about 1 teaspoon sea salt

about ½ teaspoon garlic powder

about ½ teaspoon onion powder

Alternatively, the components may be provided in the following ranges:

### Range of Embodiments:

2-4 Medium Onions—from about 200-500 grams total for both

1 Green Pepper from about—100-300 grams

1 Red Pepper—from about 100-300 grams

from about ⅛ to ½ cup Extra Virgin Olive Oil (EVOO)

from about ¼ to ½ cup apple cider vinegar

from about ½ to 1 cup water

from about ½ to 1 teaspoon oregano

from about ⅛ to ½ teaspoon black pepper

from about ½ to 1½ teaspoon sea salt

from about ¼ to ¾ teaspoon garlic powder

from about ¼ to 3/42 teaspoon onion powder

The following directions are for making single 15 oz. containers of the present invention:

1. Allow medium nonstick fry pan to pre-heat over low heat while prepping peppers and onions

2. Prepare red peppers and green peppers
a) Wash thoroughly
b) Cut open and de-seed
c) Dice into slices ranging from ¼ inch to one inch wide

3. Prepare onions
a) Peel off entire outer skin/layer
b) Chop into slices ranging from ½ inch to one inch wide

4. Combine prepared vegetables with all remaining ingredients into pre-heated nonstick fry pan.

5. Cook over medium heat (at about 200-250° F.) for 20-30 minutes, stirring occasionally, until vegetables are soft and caramelized.

6. Allow cooked ingredients to cool slightly in the nonstick fry pan

7. Place contents of nonstick fry pan into blender.

8. In blender, use puree setting for 25-45 seconds until desired consistency if achieved

9. Consistency of product should range as follows:
a) at the thinnest, consistency of a thick salad dressing (like ranch dressing)
b) at the thickest, consistency of a yellow mustard (such as Gulden's Spicy Brown Mustard)

The following directions are for special manufacturing considerations for producing multiple quantities of the present invention: (when recipe is scaled up to manufacture).

For example, due to process limitations in manufacture, vegetables are pureed or otherwise blended first and then cooked afterwards.

The manufacturer has to strain or puree to desired consistency to be able to pour out of 0.375 orifice in flip cap. After puree is produced in sufficient quantities, all ingredients are combined into a steam jacketed Kettle Cooker or equivalent heating means, such as a 150 gallon kettle cooker with a steam jacket. For mass production, using 38 gallons at a time typically yields 26 cases of twelve 15 oz containers per case. However, higher batches, such as 114 gallons or more, may be employed in a 150 steam jacketed kettle cooker. There are other applicable kettles which are provided by manufacturers, such as 200-250 gallon kettle cookers.

The ingredients are cooked at a temperature of about 200-300° F. degrees for 30-45 minutes, while being stirred occasionally.

Xanthan Gum or other thickeners, such as guar gum, corn starch or carrageenan is added as a thickener as needed to achieve viscosity.

After cooking, heat fill product into bottles, then cap. Also note, some factories can first cool down the recipe, then fill and cap the bottles.

For maximum organoleptic taste qualities, the product should maintain a pH balance below about 4.5, preferably below 4.3.

### Example 2

The following example is a Table of a preferred embodiment of the present invention, having a pH of about 4.5 or less, to make 1,050 gallons on a commercial basis.

TABLE 1

| Ingredient Name | Weight # (in lbs) | % by Weight |
|---|---|---|
| WATER | 100.08 | 1.0 |
| CORN STARCH | 340.43 | 3.7 |
| OLIVE OIL | 485.97 | 5.3 |
| APPLE CIDER VINEGAR | 688.52 | 7.5 |
| ONION PUREE | 4320.00 | 47.0 |
| GREEN PEPPER PUREE | 1620.00 | 17.7 |
| RED PEPPER PUREE | 1440.00 | 15.7 |
| OREGANO | 5.10 | 0.055 |
| BLACK PEPPER 16M | 7.62 | 0.083 |
| SEA SALT | 76.03 | 0.83 |
| GARLIC POWDER | 23.89 | 0.26 |
| ONION POWDER | 20.14 | 0.22 |
| Total | 9127.78 | 99+ |

Alternatively, the apple cider vinegar can be increased wherein the apple cider vinegar is increased in weight to 808.52 pounds to lower the pH.

In the aforementioned example 2 in Table 1, the water is first mixed with corn starch, and optionally preservatives may be added, such as potassium sorbate and sodium benzoate. (the composition can also be made without preservatives, with instructions pertaining to refrigerated shelf life). Then a blend is made of olive oil and apple cider vinegar. After mixing, onion puree, green pepper puree and red pepper puree are added to the blended mixture, along with oregano, black pepper, sea salt, garlic powder and onion powder. The resultant mixture is heated to 205 degrees Fahrenheit and kept hot as a hot fill. The product is then inserted at 160 degrees Fahrenheit in the bottle pre-flush filler with hot water, and is scheduled for bottling within 30 minutes, top prevent changing color if held for more than thirty minutes before bottling.

In the foregoing description, certain terms are used to describe the preferred embodiment. However, no unnecessary limitations are to be construed by the terms used, beyond what is shown in the prior art, since the terms are exemplary only, and are not meant to limit the scope of the present invention.

It is further known that other modifications may be made to the present invention, without departing the scope of the invention.

We claim:

1. A method of preparing a sauce for imparting onion and pepper aroma to a foodstuff comprising the steps of:
sautéing a mixture of onions and peppers in oil until caramelized, while
adding vinegar in an amount sufficient to maintain a pH balance of about 4.5 or less, water and additional flavors including spices; and
pureeing said mixture into a viscous final product that is easily used on a variety of foods as a condiment, dipping sauce, marinade or recipe flavor and aroma enhancer of authentic ethnic style sautéed peppers and onions.

2. The method of claim 1 wherein each of said onions and peppers is present in amount of about 15 to 55% by weight in the final product.

3. The method of claim 2 in which said spices include one or more of oregano, black pepper, sea salt, garlic powder, thyme, basil and onion powder, each of which would be at levels of less than about 1% of the final product.

4. The method of claim 2 in which said oil is present within the range of about 5-20% by weight of the final product.

5. The method of claim 4 in which water is present within the range of about 1.0-20% of the final product.

6. A method of preparing a sauce for imparting onion and pepper aroma to a foodstuff comprising the steps of:
preparing a pureed mixture of natural onions and natural peppers;
adding oil, vinegar and water to the pureed mixture, using sufficient vinegar to maintain a pH balance of about 4.5 or less;
heating said pureed mixture of onions and peppers with oil, vinegar and water at a temperature of 200-300 deg. F. for 30-45 minutes, or until being soft and caramelized; and
adding a thickening agent to obtain a desired viscosity.

7. The method of claim 6 wherein each of said onions and peppers is present in the amount of about 15 to 55% by weight in the final product.

8. The method of claim 7 in which the mixture is heated in a steam jacketed cooker.

9. A scaled up method of manufacturing a sauce for imparting onion and pepper aroma to a foodstuff comprising the steps of:
pureeing each of natural onions and deseeded natural peppers to a consistency to be able to pour out of a 0.375 inch orifice in a flip cap;
mixing the pureed onions and peppers along with oil, vinegar and water in a heater while stirring and cooking at a temperature of about 200-300 deg. F. for 30-45 minutes;
stirring in sufficient thickener to achieve a desired viscosity;
maintaining a pH of below about 4.5 in the final product;
heat filling the final product into bottles;
capping said bottles; and
whereby said final product packaged for marketing provides flavor and aroma enhancer of authentic ethnic style sautéed peppers and onions to any foodstuff to which it is added.

10. The method of claim 9 in which said heating is carried out in a steam jacketed cooker.

11. The method of claim 10 wherein each of said onions and peppers is present in the amount of about 15 to 55% by weight in the final product.

12. An integral sauce for imparting an onion and pepper aroma to a foodstuff comprising a mixture of:
a) pureed and sautéed onions and peppers, said pureed and sautéed peppers and onions provided together in a natural form as a base,
b) oil,
c) vinegar,
d) water,
wherein each of said onions and peppers is present in amounts of about 40 to 55% by weight in the final product,
said sauce having a pH balance of about 4.5 or under.

13. The integral sauce for imparting an onion and pepper aroma to a foodstuff of claim 12 further comprising at least one spice of the group consisting essentially of oregano, black pepper, sea salt, garlic powder, thyme, basil and onion powder, each of which are provided at levels of less than about 1% by weight of the final product.

14. The integral sauce for imparting an onion and pepper aroma to a foodstuff of claim 13 in which said oil is present within the range of about 10-20% by weight of the final product.

15. The integral sauce for imparting an onion and pepper aroma to a foodstuff of claim 14 in which water is present within the range of about 1-20% by weight of the final product.

16. The integral sauce for imparting an onion and pepper aroma to a foodstuff of claim 12 further comprising at least one stabilizer selected from the group consisting essentially of at least one starch, at least one gum thickener, at least one emulsifier, or combinations thereof.

17. The integral sauce for imparting an onion and pepper aroma to a foodstuff of claim 16 wherein said at least one starch is corn starch, and said at least one gum thickener is selected from the group consisting of xanthan gum, guar gum, corn starch and carrageenan.

18. The integral sauce for imparting an onion and pepper aroma to a foodstuff of claim 16 wherein said at least one starch is provided in an amount of about 1 to 5% by weight of the final product and said gum thickener is provided in an amount of from about 0 to about 0.5 percent by weight of the final product.

19. The integral sauce for imparting an onion and pepper aroma to a foodstuff of claim 12 wherein said pureed and sautéed peppers and onions have been caramelized and pureed such that the sautéed peppers and onions may be poured through an orifice of about 0.375 inch diameter of a dispensing bottle.

20. The integral sauce for imparting an onion and pepper aroma to a foodstuff of claim 12 wherein said sauce consists essentially of the following components by weight of the total weight of the composition:

| Ingredient Name | % by Weight |
|---|---|
| water | about 1.0 |
| corn starch | about 3.7 |
| olive oil | about 5.3 |
| apple cider vinegar | about 7.5 |
| onion puree | about 47.0 |
| green pepper puree | about 17.7 |
| red pepper puree | about 15.7 |
| oregano | about 0.055 |
| black pepper 16m | about 0.083 |
| sea salt | about 0.83 |
| garlic powder | about 0.26 |
| onion powder | about 0.22 |
| Total | 99+ |
